(19) United States
(12) Patent Application Publication
(10) Pub. No.: US 2013/0294276 A1
(43) Pub. Date: Nov. 7, 2013

(54) ESTIMATION OF CHANNEL QUALITY INDICATOR USING UNUSED CODES

(71) Applicant: Telefonaktiebolaget L M Ericsson (publ), Stockholm (SE)

(72) Inventors: Andreas Cedergren, Bjarred (SE); Anders Rosenqvist, Lund (SE)

(73) Assignee: Telefonaktiebolaget L M Ericsson (publ), Stockholm (SE)

(21) Appl. No.: 13/976,736

(22) PCT Filed: Jan. 13, 2011
(86) PCT No.: PCT/SE2011/050030

§ 371 Date: Jul. 3, 2013

(51) Int. Cl. H04W 24/02

(52) U.S. Cl. CPC H04W 24/02
USPC 370/252

(57) ABSTRACT

Methods, a user equipment and a radio network node relating to estimation of a channel quality indicator, CQI, are provided. Downlink channels of a radio communication system are associated to a plurality of codes for code division multiplexing. Each downlink channel is associated to a respective code of said plurality of codes. The radio network node obtains information about an unused code among said plurality of codes. The user equipment obtains information about the unused code. The user equipment receives a downlink transmission from the radio network node. The user equipment estimates the CQI based on the unused code, wherein the unused code is unused with respect to the received downlink transmission.

### TECHNICAL FIELD

The present disclosure relates to the field of telecommunication. In particular, the present disclosure relates to a method in a user equipment and a user equipment for estimating a channel quality indicator. Moreover, the present disclosure relates to a method in a radio network node and a radio network node for enabling estimation of a channel quality indicator by a user equipment.

### BACKGROUND

In telecommunication systems, it is often desired to estimate channel quality of a channel for sending data between a base station and a user equipment. When the channel quality has been estimated, the sending of data may be adapted to the estimated channel quality of the channel. As an example, by adapting the sending of data to the channel quality may be possible increase the data rate.

In a known telecommunication system, such as a Wideband Code Division Multiple Access (WCDMA) system, the channel quality is estimated by the user equipment and reported by the user equipment to the base station as a channel quality indicator (CQI). The channel quality indicator is based on measurements of signal strength for the sending of data and on measurements of signal strength for interference imposed to the sending of data. The measurements may be a measurement of signal-to-interference-ratio (SIR).

The signal strength for the sending of data may be estimated by measuring signal strength of reference signals, also called pilot symbols. The pilot symbols are transmitted in a slot of the WCDMA system. A transmission time interval (TTI) includes at least one slot. In the WCDMA system, 10 pilot symbols may be transmitted on a primary common pilot channel (P-CPICH) for each slot. Another 10 pilot symbols may be transmitted if a secondary common pilot channel (S-CPICH) is used. These pilot symbols are specified by a standard specification for high speed downlink packet access (HSDPA).

In the WCDMA system, a plurality of downlink channels may be associated to a plurality of codes for code division multiplexing. In this fashion, each downlink channel is associated to a respective code of said plurality of codes. A code that is not used for code division multiplexing of data may be referred to as an unused code or idle code. Thus, the signal strength for interference may be estimated by measuring on so called unused codes.

In the user equipment, the estimation of the CQI is based on combining weights. The combining weights are used to reduce so called colored interference. The user equipment comprises a generalized rake receiver (G-rake receiver), which calculates the combining weights, w, according to:

w=R⁻¹h

Where R and h are estimates of an impairments covariance matrix and a net channel response, respectively. The net channel response may be estimated by the signal strength of the reference signals. The receiver uses the impairments covariance matrix to reduce interference. For example, so called colored interference may be reduced by means of the impairments covariance matrix via the combining weights as mentioned above. The estimate h may be generated based on reference signals. Thus, by improving an estimate of the net channel response the calculated combining weights may become more accurate. As a consequence thereof, the reported CQI, based on the combining weights, may become more accurate as well.

A known non-parametric G-Rake may use unused codes in order to improve the estimate of the impairments covariance matrix. Since the unused codes do not carry any user data, they are well suited for estimation of interference from other sources. The user equipment is not aware of which codes that are not used. In known solutions, the user equipment has to detect whether a code is used or not used. If the user equipment detects that there are unused codes, these unused codes may be used to improve an estimate of the impairment covariance matrix. In this manner, gains in channel equalization may be made compared to a non-parametric G-Rake that uses only pilot symbols to generate the estimate of the impairments covariance matrix. Channel equalization is the process of reducing amplitude, frequency and phase distortion in a radio channel with the intent of improving transmission performance.

A problem with using unused codes may be that the user equipment has to detect which codes are unused. Functionality for detection of unused codes by the user equipment increases complexity of the user equipment. In addition, the detection of unused codes may be performed for one slot, while it has to be assumed that the unused codes remain the same for the slot in which the unused codes are used to improve the estimate of the impairments covariance matrix. As a result, the user equipment becomes slow in responding to changes of unused codes. Also if a presumptive unused code is in fact used for user data due to misdetection or delay, use of this presumptive unused code for covariance matrix estimation may decrease the accuracy of the estimate of the impairments covariance matrix, i.e. worsening performance of the WCDMA system.

Moreover, for High-Speed Downlink Packet Access (HSDPA) the user equipment has to detect unused codes for a period that is at least as long as delay of the so called CQI loop, otherwise there may be problems with the link adaptation, i.e. the adaptation of the sending of data mentioned in the first paragraph of this section. As a result, the user equipment may have to perform the detection of unused codes continuously, even when the user equipment is not scheduled for downlink transmission. Disadvantageously, computational resources and battery power of the user equipment will be consumed in an undesired manner.

### SUMMARY

An object of embodiments herein is to improve performance of a telecommunication system.

According to an aspect, the object is achieved by a method in a user equipment for estimating a channel quality indicator, referred to as “CQI”. The user equipment and a radio network node are comprised in a radio communication system. Downlink channels of the radio communication system are associated to a plurality of codes for code division multiplexing. Each downlink channel is associated to a respective code of said plurality of codes. The user equipment obtains information about an unused code among said plurality of codes. The user equipment receives a downlink transmission from the radio network node. The user equipment estimates the CQI based on the unused code, wherein the unused code is unused with respect to the received downlink transmission.

According to another aspect, the object is achieved by a user equipment for estimating a channel quality indicator, CQI. The user equipment and a radio network node are comprised in a radio communication system. Downlink channels of the radio communication system are associated to a plurality of codes for code division multiplexing. Each downlink channel is associated to a respective code of said plurality of codes. The user equipment comprises a receiver configured to receive a downlink transmission from the radio network node, and a processing circuit configured to obtain information about an unused code among said plurality of codes. The processing circuit is further configured to estimate the CQI based on the unused code. The unused code is unused with respect to the received downlink transmission.

According to a further aspect, the object is achieved by a method in a radio network node for enabling estimation of a channel quality indicator, CQI, by a user equipment. The radio network node and the user equipment are comprised in a radio communication system. Downlink channels of the radio communication system are associated to a plurality of codes for code division multiplexing. Each downlink channel is associated to a respective code of said plurality of codes. The radio network node obtains information about an unused code. The radio network node sends a downlink transmission to the user equipment while taking the unused code into account.

According to yet another aspect, the object is achieved by a radio network node for enabling estimation of a channel quality indicator, CQI, by a user equipment. The user equipment and a radio network node are comprised in a radio communication system. Downlink channels of the radio communication system are associated to a plurality of codes for code division multiplexing. Each downlink channel is associated to a respective code of said plurality of codes. The radio network node comprises a processing circuit configured to obtain information about an unused code, and a transmitter configured to send a downlink transmission to the user equipment while taking the unused code into account.

Since the user equipment obtains information about an unused code among said plurality of codes, it is assured that the user equipment has accurate information about which codes are unused codes. By use of the unused code, an estimate of the impairments covariance matrix may be improved. As a consequence thereof, combining weights may be more accurately determined. In turn, this leads to that a higher CQI may be reported by the user equipment to the radio network node. With a higher CQI performance of the radio communication system may be improved. Thus, the above mentioned object is achieved.

An advantage of embodiments herein is that the information about the unused code is reliable, i.e. no detection of the unused code (or codes) is needed instead accurate information about the unused code is available to the user equipment.

Another advantage of embodiments herein is that the information about the unused code is accurately valid for the downlink transmission to be sent, i.e. there is no delay which may result from detection of the unused code according to prior art.

A further advantage of embodiments herein is that estimation of the impairments covariance matrix for advanced receivers such as G-Rake receivers may be improved without need for any extra pilot symbols (or pilot signals) or without need for changes of related standard specifications.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 shows a schematic overview of an exemplifying radio communication system,

FIG. 2 shows a schematic, combined signalling and flow chart of an exemplifying method in the radio communication system according to FIG. 1 for estimating a channel quality indicator,

FIG. 3 shows a schematic flow chart of the method of FIG. 2 when seen from the user equipment,

FIG. 4 shows a schematic block diagram of an exemplifying user equipment configured to estimate a channel quality indicator,

FIG. 5 shows a schematic flow chart of the method of FIG. 2 when seen from the radio network node,

FIG. 6 shows a schematic block diagram of an exemplifying radio network node configured to enable estimation of a channel quality indicator by a user equipment, and

FIG. 7 shows a schematic diagram of an exemplifying code tree.

### DETAILED DESCRIPTION

Throughout the following description similar reference numerals have been used to denote similar elements, parts, items or features, when applicable. In the Figures, features that appear in some embodiments are indicated by dashed lines.

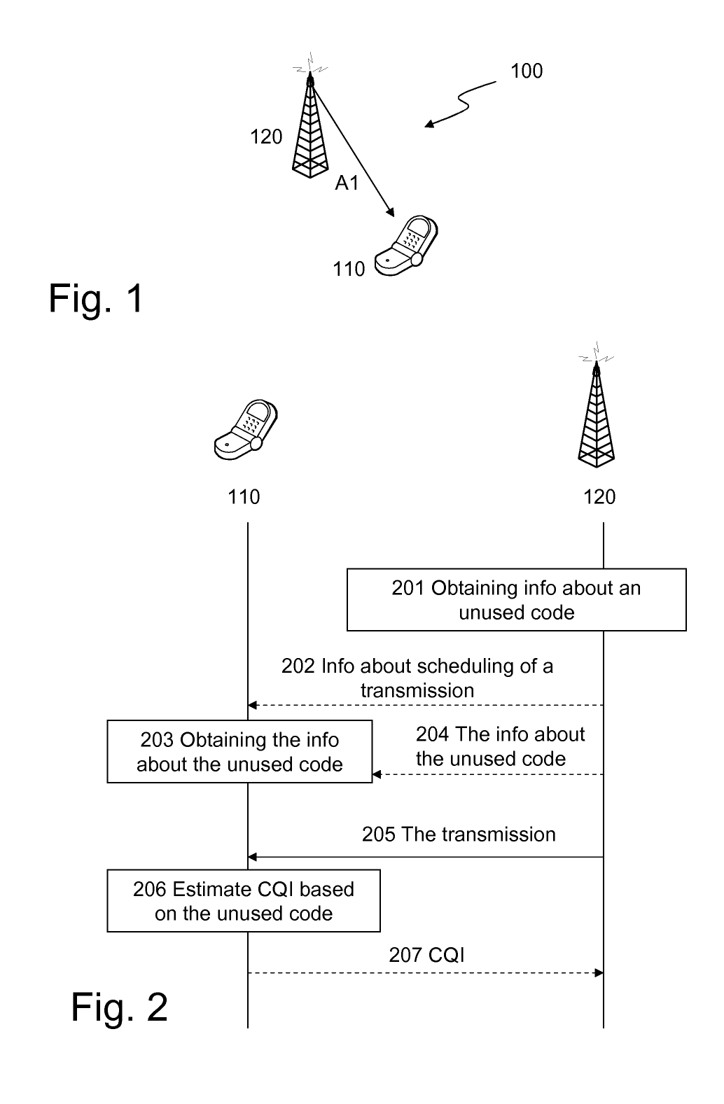

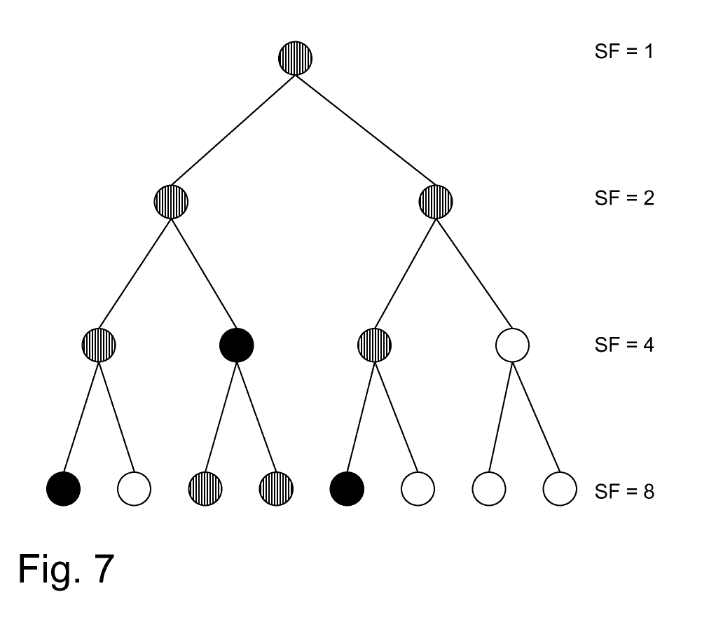

FIG. 1 shows a schematic overview of an exemplifying radio communication system 100, such as a WCDMA system. The radio communication system 100 comprises a radio network node 120, such as a radio base station, and a user equipment 110. An arrow Al indicates that a downlink transmission may be sent to the user equipment 110 from the radio network node 120. The downlink transmission may utilize one or more of a plurality of downlink channels. The downlink channels are associated to a plurality of codes for code division multiplexing. Each downlink channel is associated to a respective code of said plurality of codes for code division multiplexing. Each of said plurality of codes may comprise a channelization code and a spreading factor as described in conjunction with FIG. 7.

As used herein, a user equipment may be a mobile phone, a cellular phone, a Personal Digital Assistant (PDA) equipped with radio communication capabilities, a smart phone, a laptop equipped with an internal or external mobile broadband modem, a portable electronic radio communication device or the like.

In the user equipment 110, the estimation of the CQI is based on combining weights. The combining weights are used to reduce so called colored interference. The user equipment 110 comprises a generalized rake receiver (G-rake receiver), which calculates the combining weights, w, according to:

w=R⁻¹h

Where R and h are estimates of an impairments covariance matrix and a net channel response, respectively. The net channel response may be estimated by the signal strength of the reference signals. The receiver uses the impairments covariance matrix to reduce interference. For example, so called colored interference may be reduced by means of the impairments covariance matrix via the combining weights as mentioned above. The estimate h may be generated based on reference signals. Thus, by improving an estimate of the net channel response the calculated combining weights may become more accurate. As a consequence thereof, the reported CQI, based on the combining weights, may become more accurate as well.

Turning to FIG. 2, there is shown a schematic combined signalling and flow chart of an exemplifying method in the radio communication system 100 according to FIG. 1 for estimating a channel quality indicator. The following actions, such as steps, may be performed. Notably, in some embodiments of the method the order of the actions may differ from what is indicated below and/or in the Figure.

### Action 201

The radio network node 120 obtains information, referred to as “info” in the Figure, about an unused code. As an example, the radio network node 120 may read the information about the unused code from a memory of the radio network node 120 when the unused code is predetermined. As another example, the information about the unused code may be dynamically determined. The information about the unused code indicates a code, or a channel, which is not used. It is further explained what is considered to be an unused code in conjunction with FIG. 7.

In some embodiments, the dynamically determined unused code may be determined by the radio network node 120 as being at least one code between a first used code and a second used code. As an example, codes between primary common control physical channel (P-CCPCH) and a high-speed shared control channel (HS-SCCH) with a lowest code number among the code numbers of said plurality of codes are unused. The user equipment 110 has previously been informed about how the unused code is determined by the radio network node. Thus, the user equipment 110 may obtain the information about the unused code by determining the unused code based on for example the information for scheduling as in some embodiments of action 202 below.

### Action 202

In some embodiments, the radio network node 120 sends and the user equipment 110 receives information about a scheduling of the downlink transmission. In these embodiments, the information about the scheduling of the transmission may be determined by the radio network node 120 while taking the unused code into account. Thus, the downlink transmission may be scheduled by means of the information about scheduling to be carried by at least one of the downlink channels, while taking the unused code into account. In this manner, at least one respective code of said one of the downlink channels is used by, or allocated to, the downlink transmission. As an example, the unused code may be taken into account in that the unused code is not allocated with data of the downlink transmission. Since the unused code, i.e. the channel represented by the unused code, does not carry any information, the unused code may be used for measurements of the impairments covariance matrix, which may indicate interference exposed to the user equipment 110.

In some embodiments, the information about scheduling is carried by a first shared control channel, such as a first high-speed shared control channel (HS-SCCH).

### Action 203

The user equipment 110 obtains information about an unused code among said plurality of codes. As a result, the unused code may be used for improving the estimate of the impairments covariance matrix as described in conjunction with action 206 below.

In some embodiments, the obtaining of information about the unused code may be that the user equipment 110 determines the unused code as being at least one code between a first used code and a second used code. The first and second used codes are derived from the information about scheduling. As an example, codes between primary common control physical channel (P-CCPCH) and a high-speed shared control channel (HS-SCCH) with a lowest code number among said plurality of codes are unused.

### Action 204

In some embodiments, the obtaining of information about the unused code may be that the user equipment 110 receives the information about the unused code from the radio network node 120. This means that the radio network node 120 sends the information about the unused code to the user equipment 110. In this manner, the user equipment 110 may receive the information about the unused code, when the user equipment has not been informed about how the unused code has been determined.

When the information about the unused code is sent frequently by the radio network node in conjunction with the information about scheduling of the downlink transmission, the radio network node 120 may perform fast and adaptive changes of the unused code as required by current radio conditions.

The fast, adaptive changes according to the current radio conditions may be in response to if the unused code is useful or not to the user equipment 110. As an example, the user equipment 110 may send an acknowledgement (ACK) message to the radio network node 120. The ACK message may be used to confirm that the user equipment 110 is configured, for example by means of software, to be able to handle information about the unused code. This will be referred to as an ACK mechanism below. As an example, the HS-DPCCH HARQ-ACK (high speed downlink physical control channel hybrid automatic repeat request acknowledgment) in uplink may be used by the user equipment 110 to send an ACK for a transmission time interval (TTI) when no high-speed data is received from the radio network node 120. In this manner, the radio network node 120 may detect if the user equipment 110 uses the information about the unused code. Hence, if it is detected that the user equipment 110 does not use the unused code, the radio network node 120 may turn off the sending of information about the unused code. Moreover, the radio network node 120 may store information about if the user equipment 110 uses the unused code or if it does not use the unused code. The radio network node 120 may also detect that the user equipment 110 does not use the information about the unused code by means of the previously mentioned ACK mechanism.

The information about the unused code may be carried by a second shared control channel, such as a second HS-SCCH.

In some embodiments, the second shared control channel is identified by an identifier for identifying an intended recipient, such as another user equipment, of the information carried by the second shared control channel. The identifier may be received by the user equipment 110 from the radio network node 120. In this manner, by being informed about the identifier that represents another user equipment, the user equipment is capable of receiving information about the unused code.

As an example, the second HS-SCCH may have a specific user equipment identifier which is not associated to the user equipment 110, but to another user equipment. However, since the user equipment 110 has received the identifier, the user equipment will be able to receive and capture (or decode) information about unused codes sent on the second HS-SCCH with the specific user equipment identifier. If the user equipment 110 successfully decodes the information on the second HS-SCCH for unused codes, it uses unused codes when computing the impairment covariance matrix. If there are no unused codes available, the impairment covariance matrix may be computed while using only pilot symbols.

It is to be understood that, in some embodiments, the identifier for identifying an intended recipient of the information carried by the second shared control channel may be predetermined. In this manner, no signalling of the identifier is required.

Now that the identifier has been explained, it may be noted that the first shared control channel may have a first identifier, such as a user equipment identifier, that is associated to the user equipment 110. As a result, the user equipment 110 will be able to receive and capture the information for scheduling as intended.

In some embodiments, the user equipment 110 decodes the information about scheduling (received in action 202) and decodes the information about the unused code (received in action 204). The decoding of the information about the unused code is possible thanks to the received identifier of the second shared control channel.

In some embodiments, the information about scheduling and the information about the unused code are received in a first transmission time interval (TTI).

### Action 205

The radio network node 120 sends and the user equipment 110 receives a downlink transmission. As an example, the downlink transmission is sent to the user equipment 110 according to the information about scheduling of the downlink transmission (sent by the radio network node 120 to the user equipment 110 in action 202).

In some embodiments, the downlink transmission may be received in a second transmission time interval. The second transmission time interval may be subsequent the first TTI. As an example, the second TTI may be directly adjacent the first TTI.

Moreover, the downlink transmission may be carried by a physical downlink shared channel, such as a high-speed physical downlink shared channel (HS-PDSCH).

### Action 206

The user equipment 110 estimates the CQI based on the unused code. The CQI may be based on the unused code, because the CQI is based on combining weights, which in turn depend on the impairments covariance matrix and the net channel response according to w=R⁻¹h above. The impairment covariance matrix may be calculated from signal strength for unused codes, i.e. a measure of interference. Hence, the estimate of the CQI is improved since the impairments covariance matrix has been improved. The unused code is unused with respect to the received downlink transmission. As an example, an unused code may be a code that is idle with respect to the downlink transmission. Such code may be called an idle code, because it is not used for transmitting data of the transmission.

### Action 207

In some embodiments, the user equipment 110 sends and the radio network node 120 receives the estimated CQI.

In some embodiments, the radio network node 120 may adjust modulation, transport block size (TrBlkSize), power of downlink transmission and the like based the received CQI. In this manner the downlink transmission is adapted to current radio conditions.

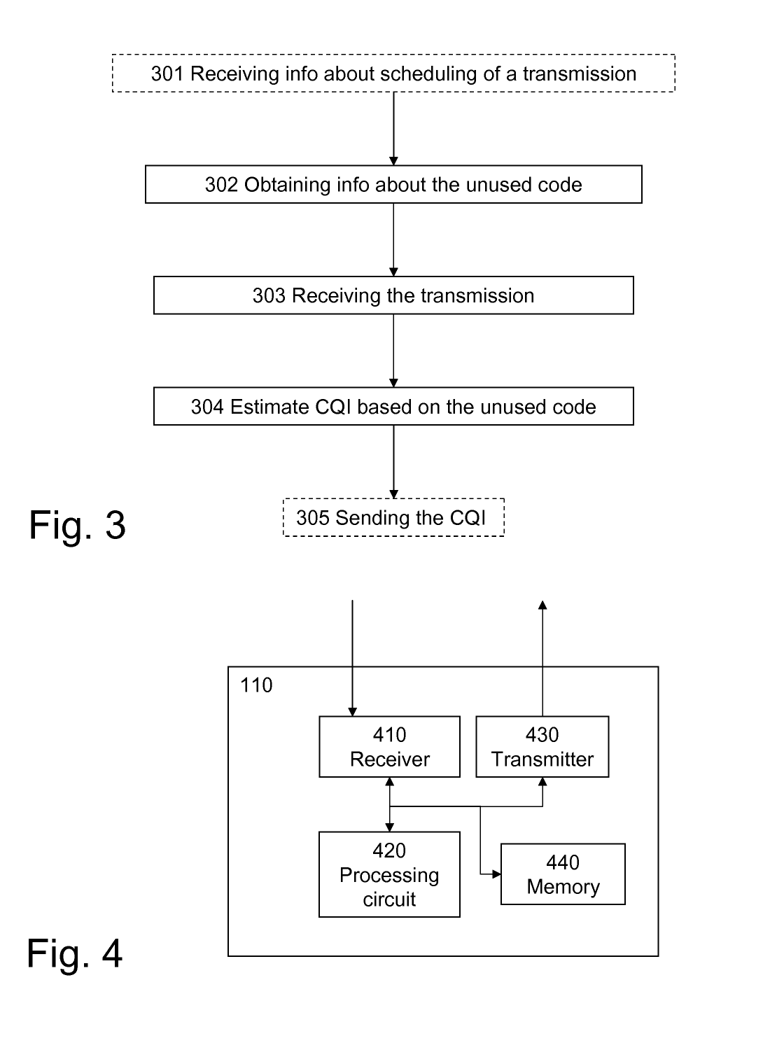

In FIG. 3, there is shown an exemplifying, schematic flow chart of the method for estimating the CQI of FIG. 2 when seen from the user equipment 110. As mentioned above, the user equipment 110 and the radio network node 120 are comprised in the radio communication system 100. Downlink channels of the radio communication system 100 are associated to a plurality of codes for code division multiplexing. Each downlink channel is associated to a respective code of said plurality of codes. Each of said plurality of codes may comprise a channelization code and a spreading factor. The following actions, such as steps, may be performed. Notably, in some embodiments of the method the order of the actions may differ from what is indicated below and/or in the Figure.

### Action 301

Action 301 is similar to action 202. In some embodiments of the method in the user equipment 110, the user equipment 110 receives from the radio network node 120 information about scheduling of the downlink transmission to the user equipment 110. The downlink transmission is scheduled to be carried by at least one of the downlink channels. In this manner at least one respective code of said one of the downlink channels is used for transmission of the downlink transmission.

In some embodiments of the method in the user equipment 110, the information about scheduling is carried by a first shared control channel, such as a first high-speed shared control channel (HS-SCCH). The first shared control channel may have a user equipment identifier associated to the user equipment 110.

### Action 302

Action 302 is similar to action 203. The user equipment 110 obtains information about an unused code among said plurality of codes.

In some embodiments of the method in the user equipment 110, the obtaining 302 of information about the unused code may be that the user equipment 110 receives the information about the unused code from the radio network node 120. This is similar to action 204.

In some embodiments of the method in the user equipment 110, the information about scheduling and the information about the unused code are received in a first transmission time interval (TTI).

In some embodiments of the method in the user equipment 110, the information about the unused code is carried by a second shared control channel, such as a second HS-SCCH.

In some embodiments of the method in the user equipment 110, the second shared control channel is identified by an identifier for identifying an intended recipient of the information carried by the second shared control channel. The identifier is received by the user equipment 110 from the radio network node 120. The identifier for identifying an intended recipient may be a user equipment identifier, such as an UE_id.

In some embodiments of the method in the user equipment 110, the obtaining 302 of information about the unused code may be that the user equipment 110 determines the unused code as being at least one code between a first used code and a second used code. The first and second used codes may be derived from the information about scheduling. As an example, codes between primary common control physical channel (P-CCPCH) and a high-speed shared control channel (HS-SCCH) with a lowest code number among the code numbers of said plurality of codes are unused.

In some embodiments of the method in the user equipment 110, the unused code is predetermined. In this manner, it is assured that some codes are always reserved for interference estimation. Moreover, the codes may be used for noise estimation as well. Hence, as an example, the obtaining 302 of information about the unused code may be that the user equipment reads the information about the unused code from a memory of the user equipment 110. Information about the predetermined unused code may be stored on the memory.

### Action 303

Action 303 is similar to action 205. The user equipment 110 receives a downlink transmission from the radio network node 120.

In some embodiments of the method in the user equipment 110, the downlink transmission is received on a physical downlink shared channel, such as a high-speed physical downlink shared channel (HS-PDSCH).

In some embodiments of the method in the user equipment 110, the downlink transmission is received in a second transmission time interval. The second transmission time interval may be subsequent the first TTI. As an example, the second TTI may be directly adjacent the first TTI.

### Action 304

Action 304 is similar to action 206. The user equipment 110 estimates the CQI based on the unused code. The unused code is unused with respect to the received downlink transmission. As an example, an unused code may be a code that is idle with respect to the transmission. Such code may be called an idle code, because it does not code any channel of the transmission.

### Action 305

Action 305 is similar to action 207. In some embodiments of the method in the user equipment 110, the user equipment 110 sends the estimated CQI to the radio network node 120.

With reference to FIG. 4, there is shown a schematic block diagram of the user equipment 110 configured to perform the method actions above for estimation of the CQI. As mentioned above, the user equipment 110 and a radio network node 120 are comprised in a radio communication system 100. Downlink channels of the radio communication system 100 are associated to a plurality of codes for code division multiplexing. Each downlink channel is associated to a respective code of said plurality of codes. Each of said plurality of codes may comprise a channelization code and a spreading factor as described in conjunction with FIG. 7.

The user equipment 110 further comprises a processing circuit 420 configured to obtain information about an unused code among said plurality of codes. The processing circuit 420 further is configured to estimate the CQI based on the unused code. The unused code is unused with respect to the received downlink transmission.

In some embodiments of the user equipment 110, the processing circuit 420 may be a processing unit, a processor, an application specific integrated circuit (ASIC), a field-programmable gate array (FPGA) or the like. As an example, a processor, an ASIC, an FPGA or the like may comprise one or more processor kernels.

In some embodiments of the user equipment 110, the processing circuit 420 is configured to determine the unused code as being at least one code between a first used code and a second used code. The first and second used codes are derived from the information about scheduling.

The user equipment 110 further comprises a receiver 410 configured to receive a downlink transmission from the radio network node 120.

In some embodiments of the user equipment 110, the receiver 410 is configured to receive the downlink transmission on a physical downlink shared channel.

In some embodiments of the user equipment 110, the receiver 410 is further configured to receive, from the radio network node 120, information about scheduling of the downlink transmission to the user equipment 110. The downlink transmission is scheduled to be carried by at least one of the downlink channels.

In some embodiments of the user equipment 110, the receiver 410 is configured to receive the information about the unused code from the radio network node 120.

In some embodiments of the user equipment 110, the receiver 410 is further configured to receive the information about scheduling and the information about the unused code in a first transmission time interval.

In some embodiments of the user equipment 110, the receiver 410 is further configured to receive the downlink transmission in a second transmission time interval.

In some embodiments of the user equipment 110, the receiver 410 is further configured to receive the information about scheduling on a first shared control channel and the information about the unused code on a second shared control channel.

In some embodiments of the user equipment 110, the second shared control channel is identified by an identifier for identifying an intended recipient of the information carried by the second shared control channel. The identifier for identifying an intended recipient may be a user equipment identifier. The identifier is received by the user equipment 110 from the radio network node 120. Thus, the receiver 410 is further configured to receive the identifier for identifying an intended recipient of the information carried by the second shared control channel. In this manner, the user equipment 110 is capable of receiving information about the unused code carried by the second shared control channel by means of the identifier.

In some embodiments of the user equipment 110, the user equipment 110 may further comprise a memory 440 for storing software to be executed by, for example, the processing circuit. The software may comprise instructions to enable the processor to perform the method in the user equipment 110 as described above in conjunction with FIG. 3. The memory 440 may be a hard disk, a magnetic storage medium, a portable computer diskette or disc, flash memory, random access memory (RAM) or the like. Furthermore, the memory may be an internal register memory of a processor.

In some embodiments of the user equipment 110, the unused code is predetermined. As an example, when the unused code is predetermined the processing circuit may be configured to store the unused code in the memory 440. In this example, the memory may be a non-volatile memory in order to preserve information stored in the memory also when the memory is not supplied with electrical power.

In some embodiments of the user equipment 110, the user equipment 110 further comprises a transmitter 430 configured to send the estimated CQI to the radio network node 120.

As an example, the user equipment 110 may comprise a G-rake receiver, which comprises the receiver 410, the processing circuit 420 and the memory 440.

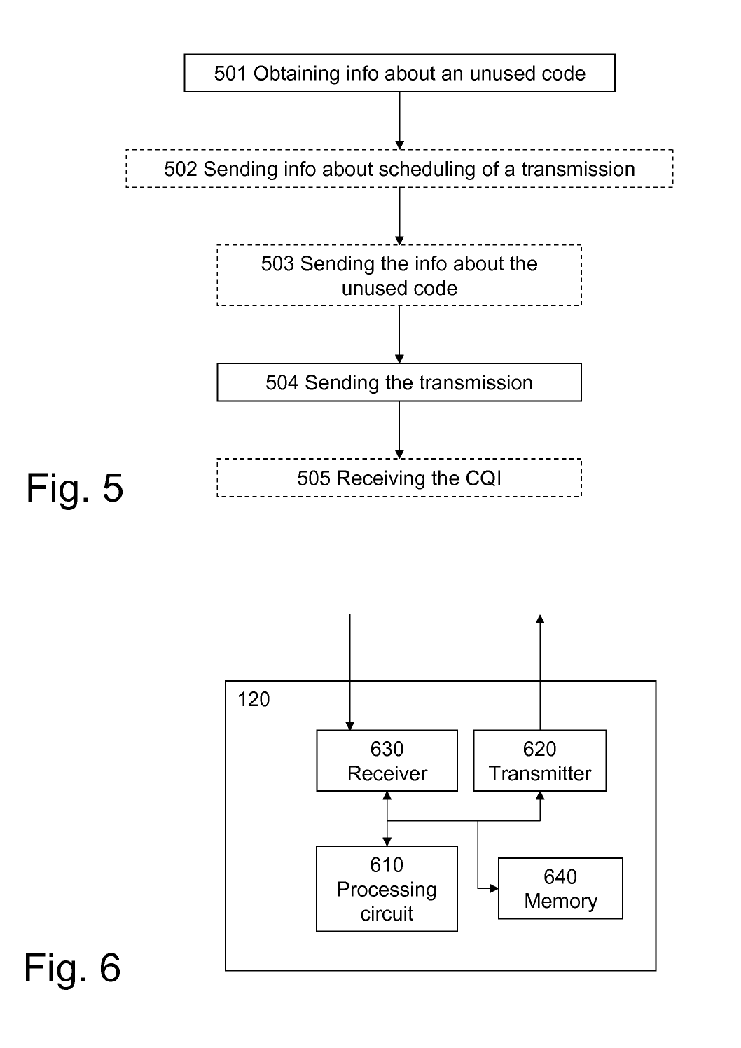

In FIG. 5, there is shown a schematic flow chart of the method of FIG. 2 when seen from the radio network node 120. The radio network node 120 performs a method for enabling estimation by the user equipment 110 of the CQI. As mentioned above, the radio network node 120 and the user equipment 110 are comprised in the radio communication system 100. Downlink channels of the radio communication system 100 are associated to a plurality of codes for code division multiplexing. Each downlink channel is associated to a respective code of said plurality of codes. Each of said plurality of codes may comprise a channelization code and a spreading factor. The following actions may be performed. Notably, the order of the actions may in some embodiments differ from what is indicated below and/or in the Figure.

### Action 501

Action 501 is similar to action 201. The radio network node 120 obtains information about an unused code. As an example, the radio network node 120 may read the information about the unused code from a memory of the radio network node 120 when the unused codes are predetermined. As another example, the information about an unused code may be dynamically determined.

In some embodiments of the method in the radio network node 120, the radio network node 120 determines the unused code as being at least one code between a first used code and a second used code.

### Action 502

Action 502 is similar to action 202. The radio network node 120 sends information about scheduling of the downlink transmission to the user equipment 110. The downlink transmission is scheduled (by means of the information about scheduling) to be carried by at least one of the downlink channels, while taking the unused code into account.

In some embodiments of the method in the radio network node 120, the information about scheduling of the transmission may be determined by the radio network node 120 while taking the unused code into account.

In some embodiments of the method in the radio network node 120, the information about scheduling is carried by a first shared control channel, such as a first HS-SCCH having a user equipment identifier of the user equipment 110.

In some embodiments of the method in the radio network node 120, the information about scheduling is sent in a first transmission time interval.

### Action 503

Action 503 is similar to action 204. In some embodiments of the method in the radio network node 120, the radio network node 120 sends the information about the unused code to the user equipment 110.

In some embodiments of the method in the radio network node 120, the information about the unused code is carried by a second shared control channel, such as a second HS-SCCH.

In some embodiments, the second shared control channel is identified by an identifier for identifying an intended recipient of the information carried by the second shared control channel. The identifier is sent by the radio network node 120 to the user equipment 110.

In some embodiments of the method in the radio network node 120, the information about the unused code is sent in the first transmission time interval.

### Action 504

Action 504 is similar to action 205. The radio network node 120 sends a downlink transmission to the user equipment 110. As an example, the downlink transmission is sent to the user equipment 110 according to the information about scheduling of the downlink transmission (sent in action 502).

In some embodiments of the method in the radio network node 120, the downlink transmission is sent on a physical downlink shared channel, such as HS-PDSCH.

In some embodiments of the method in the radio network node 120, the downlink transmission is sent in a second transmission time interval.

### Action 505

Action 505 is similar to action 207. In some embodiments of the method in the radio network node 120, the radio network node 120 receives a CQI estimated by the user equipment 110.

In some embodiments of the method in the radio network node 120, the radio network node adjusts modulation, transport block size (TrBlkSize) and the like based the received CQI.

Referring to FIG. 6, there is shown a schematic block diagram of the radio network node 120 configured to perform the actions above for enabling estimation of the CQI. As mentioned above, the user equipment 110 and the radio network node 120 are comprised in the radio communication system 100. Downlink channels of the radio communication system 100 are associated to a plurality of codes for code division multiplexing. Each downlink channel is associated to a respective code of said plurality of codes. Each of said plurality of codes may comprise a channelization code and a spreading factor as described in conjunction with FIG. 7.

The radio network node 120 comprises a processing circuit 610 configured to obtain information about an unused code.

In some embodiments of the radio network node 120, the processing circuit 610 may be a processing unit, a processor, an application specific integrated circuit (ASIC), a field-programmable gate array (FPGA) or the like. As an example, a processor, an ASIC, an FPGA or the like may comprise one or more processor kernels.

In some embodiments of the radio network node 120, the processing circuit 610 is further configured to determine the unused code as being at least one code between a first used code and a second used code.

In some embodiments of the radio network node 120, the processing circuit 610 is further configured to determine the information about scheduling of the transmission while taking the unused code into account.

The radio network node 120 comprises a transmitter 620 configured to send a downlink transmission to the user equipment 110.

In some embodiments of the radio network node 120, the transmitter 620 is further configured to send the downlink transmission in a second transmission time interval.

In some embodiments of the radio network node 120, the transmitter 620 is further configured to send the information about the unused code to the user equipment 110.

In some embodiments of the radio network node 120, the transmitter 620 is further configured to send, to the user equipment 110, information about scheduling of the downlink transmission to the user equipment 110. The downlink transmission is scheduled to be carried by at least one of the downlink channels, while taking the unused code into account.

In some embodiments of the radio network node 120, the transmitter 620 is further configured to send the information about scheduling on a first shared control channel and the information about the unused code on a second shared control channel.

In some embodiments of the radio network node 120, the second shared control channel is identified by an identifier for identifying an intended recipient of the information carried by the second shared control channel. The identifier for identifying an intended recipient may be a user equipment identifier. The identifier is sent by the radio network node 120 to the user equipment 110. Thus, the transmitter 620 is further configured to send, to the user equipment 110, an identifier for identifying an intended recipient of the information carried by the second shared control channel. In this manner, the user equipment 110 is capable of receiving information about the unused code carried by the second shared control channel by means of the identifier.

In some embodiments of the radio network node 120, the transmitter 620 is further configured to send the downlink transmission on a physical downlink shared channel.

In some embodiments of the radio network node 120, the transmitter 620 is further configured to send the information about scheduling and the information about the unused code in a first transmission time interval.

In some embodiments of the radio network node 120, the radio network node 120 may further comprise a memory 640 for storing software to be executed by, for example, the processing circuit. The software may comprise instructions to enable the processor to perform the method in the radio network node 120 as described above in conjunction with FIG. 5. The memory 640 may be a hard disk, a magnetic storage medium, a portable computer diskette or disc, flash memory, random access memory (RAM) or the like. Furthermore, the memory may be an internal register memory of a processor.

In some embodiments of the radio network node 120, the radio network node 120 further comprises a receiver 630 configured to receive the estimated CQI from the user equipment 110.

In the embodiments above, it is suggested that some codes are always unused. Therefore, in some embodiments of the method in the radio network node 120, it may be possible to turn off the use of unused codes. Thus, when the radio network node 120 detects that the reported CQI does not increase thanks to use of the unused code (or codes), the radio network node 120 turns off the sending of information about the unused code (or codes). In this manner, sending of information about the unused code is avoided when the user equipment does not benefit from the information about the unused code. The radio network node 120 may also detect that the user equipment 110 does not use the information about the unused code by means of the previously mentioned ACK mechanism.

Furthermore, it has been noted that the reported CQI may depend on the number unused codes available to the user equipment. For the radio network node to select proper transport block size, number of codes, modulation and power when transmitting new HS-data (high speed data) to the user equipment, the radio network node may need to adjust for the number of unused codes that was available when the CQI was estimated and the current number of available unused codes. If the number of unused codes changes from when the CQI was reported until it is to be used, the radio network node may predict the corresponding change in CQI. The radio network node may estimate the corresponding change by computing a difference in the reported CQI every time the number of unused codes changes. Based on the difference in number of unused codes, the corresponding change and the received CQI, the radio network node may then more accurately select transport block size, number of codes, modulation and power in view of the present channel quality indicator. In this manner, uncertainty in CQI is avoided.

In addition to the advantages mentioned in section summary, a further advantage of the methods, the user equipment and the radio network node presented herein may be that implementation only requires an update of software in the radio network node and in the user equipment.

Moreover, since the added computational load due to the methods presented herein is small, both for the radio network node and for the user equipment, hardware changes are not expected to be needed.

Furthermore, the power consumption of the user equipment is not expected to be affected by the introduction of the methods presented herein.

Now turning to FIG. 7, there is shown a schematic, exemplifying code tree. With reference to the code tree shown in FIG. 7, it will be further explained which codes are considered to be used and unused with respect to a code that is used in a transmission of data. In the Figure each node of the code tree is indicated by black solid, striped and empty (or white) bullets. Each bullet represents a code for code division multiplexing. The first row comprising only one bullet, SF=1, represents a code with spreading factor (SF) one. The second row SF=2 of bullets, represents codes with spreading factor two. Similarly, the third and fourth rows of bullets represent codes with spreading factors four and eight, respectively. Codes, shown as bullets in the Figure, located in the same row have the same spreading factor but different channelization codes. Black solid bullets denote codes that are used. Striped bullets denote codes that are unavailable due to used codes (black solid bullets). White bullets denote codes that are so called unused codes or idle codes. The spreading factor is known to be the ratio of a chip rate and a symbol rate. The chip rate of a code is the number of pulses per second (chips per second) at which the code is transmitted (or received). The symbol rate is the number of symbols per second at which symbols are transmitted (or received). The chip rate is larger than the symbol rate, meaning that one symbol may be represented by multiple chips. The channelization code is used for separation of information to be transmitted (or received) on different channels.

Even though embodiments of the various aspects have been described, many different alterations, modifications and the like thereof will become apparent for those skilled in the art. The described embodiments are therefore not intended to limit the scope of the invention, which is defined by the appended claims.

1. A method in a user equipment for estimating a Channel Quality Indicator, CQI, wherein the user equipment and a radio network node are comprised in a radio communication system, wherein downlink channels of the radio communication system are associated to a plurality of codes for code division multiplexing, wherein each downlink channel is associated to a respective code of said plurality of codes, wherein the method comprises:
obtaining information about an unused code among said plurality of codes;
receiving a downlink transmission from the radio network node; and
estimating the CQI based on the unused code, wherein the unused code is unused with respect to the received downlink transmission.

2. The method in the user equipment according to claim 1, wherein the obtaining of information about the unused code is performed by receiving the information about the unused code from the radio network node.

3. The method in the user equipment according to claim 1, wherein the unused code is predetermined.

4. The method in the user equipment according to claim 1, wherein the obtaining of information about the unused code is performed by determining the unused code as being at least one code between a first used code and a second used code, wherein the first and second used codes are derived from the information about scheduling.

5. The method in the user equipment according to claim 1, wherein the method further comprises:
sending the estimated CQI to the radio network node.

6. The method in the user equipment according to claim 1, wherein the method further comprises:
receiving from the radio network node information about scheduling of the downlink transmission to the user equipment, wherein the downlink transmission is scheduled to be carried by at least one of the downlink channels.

7. The method in the user equipment according to any claim 1, wherein the information about scheduling is carried by a first shared control channel and the information about the unused code is carried by a second shared control channel.

8. The method in the user equipment according to claim 7, wherein the second shared control channel is identified by an identifier for identifying an intended recipient of the information carried by the second shared control channel, the identifier being received by the user equipment from the radio network node.

9. The method in the user equipment according to claim 1, wherein the receiving of the downlink transmission is received on a physical downlink shared channel.

10. The method in the user equipment according to claim 8, wherein the identifier for identifying an intended recipient is a user equipment identifier.

11. The method in the user equipment according to claim 2, wherein the receiving of information about scheduling and the receiving of information about the unused code are received in a first transmission time interval.

12. The method in the user equipment according to claim 1, wherein the receiving of the downlink transmission is received in a second transmission time interval.

13. The method in the user equipment according to any claim 1, wherein each of said plurality of codes comprises a channelization code and a spreading factor.

14. A user equipment for estimating a Channel Quality Indicator, CQI, wherein the user equipment and a radio network node are comprised in a radio communication system, wherein downlink channels of the radio communication system are associated to a plurality of codes for code division multiplexing, wherein each downlink channel is associated to a respective code of said plurality of codes, wherein the user equipment comprises:
a receiver configured to receive a downlink transmission from the radio network node, and
a processing circuit configured to obtain information about an unused code among said plurality of codes, wherein the processing circuit further is configured to estimate the CQI based on the unused code, wherein the unused code is unused with respect to the received downlink transmission.

15. A method in a radio network node for enabling estimation of a Channel Quality Indicator, CQI, by a user equipment, wherein the radio network node and the user equipment are comprised in a radio communication system, wherein downlink channels of the radio communication system are associated to a plurality of codes for code division multiplexing, wherein each downlink channel is associated to a respective code of said plurality of codes, wherein the method comprises:
obtaining information about an unused code; and
sending a downlink transmission to the user equipment while taking the unused code into account.

16. The method in the radio network node according to claim 15, wherein the method further comprises:
sending the information about the unused code to the user equipment.

17. The method in the radio network node according to claim 15, wherein the method further comprises:
receiving the estimated CQI from the user equipment.

18. The method in the radio network node according to claim 15, wherein the obtaining is performed by determining the unused code as being at least one code between a first used code and a second used code.

19. The method in the radio network node according to claim 15, wherein the method further comprises:
sending to the user equipment information about scheduling of the downlink transmission to the user equipment, wherein the downlink transmission is scheduled to be carried by at least one of the downlink channels, while taking the unused code into account.

20. The method in the radio network node according to claim 15, wherein the information about scheduling of the transmission is determined by the radio network node while taking the unused code into account.

21. The method in the radio network node according to claim 15, wherein the information about scheduling is carried by a first shared control channel and the information about the unused code is carried by a second shared control channel.

22. The method in the radio network node according to claim 21, wherein the second shared control channel is identified by an identifier for identifying an intended recipient of the information carried by the second shared control channel, which identifier is sent by the radio network node to the user equipment.

23. The method in the radio network node according to claim 22, wherein the identifier for identifying an intended recipient is a user equipment identifier.

24. The method in the radio network node according to claim 15, wherein the sending of the downlink transmission is sent on a physical downlink shared channel.

25. The method in the radio network node according to claim 16, wherein the sending of information about scheduling and the sending of information about the unused code are sent in a first transmission time interval.

26. The method in the radio network node according to claim 15, wherein the sending of the downlink transmission is sent in a second transmission time interval.

27. The method in the radio network node according to claim 15, wherein each of said plurality of codes comprises a channelization code and a spreading factor.

28. A radio network node for enabling estimation of a Channel Quality Indicator, CQI, by a user equipment, wherein the user equipment and a radio network node are comprised in a radio communication system, wherein downlink channels of the radio communication system are associated to a plurality of codes for code division multiplexing, wherein each downlink channel is associated to a respective code of said plurality of codes, wherein the radio network node comprises:
a processing circuit configured to obtain information about an unused code, and
a transmitter configured to send a downlink transmission to the user equipment while taking the unused code into account.
